(19) United States
(12) Patent Application Publication
(10) Pub. No.: US 2017/0282244 A1
(43) Pub. Date: Oct. 5, 2017

(54) THREE-DIMENSIONAL MANUFACTURING APPARATUS AND THREE-DIMENSIONAL MANUFACTURING METHOD

(71) Applicant: CANON KABUSHIKI KAISHA, Tokyo (JP)

(72) Inventors: Tomoyasu Mizuno, Yokohama-shi (JP); Koji Kitani, Chofu-shi (JP)

(21) Appl. No.: 15/456,808

(22) Filed: Mar. 13, 2017

(30) Foreign Application Priority Data
Mar. 31, 2016 (JP) 2016-073537

(51) Int. Cl. B22F 3/105; B33Y 10/00; B28B 17/04; B28B 1/00; B28B 17/00; B33Y 30/00; B33Y 50/02

(52) U.S. Cl. CPC B22F 3/1055; B33Y 30/00; B33Y 10/00; B33Y 50/02; B28B 1/001; B28B 17/0081; B28B 17/04; B22F 2003/1056; B22F 2003/1057

(57) ABSTRACT

A three-dimensional manufacturing apparatus and a three-dimensional manufacturing method easily adjust a heating quantity per unit area individually for a solidified region and a non-solidified region of a powder material. A layer formation unit forms a layer of a powder material. Light sources and heat scanning units heat the layer by laser beams. The laser beam heats a solidified region in which the powder material has been fused and solidified. The laser beam heats the non-solidified region of the powder material, which is adjacent to the solidified region. The controlling section controls the light sources and the heat scanning units so as to move the laser beams along a boundary between the solidified region and the non-solidified region, and to fuse and solidify a manufacturing region of the layer.

### BACKGROUND OF THE INVENTION

### Field of the Invention

The present invention relates to a three-dimensional manufacturing apparatus and a three-dimensional manufacturing method for manufacturing a three-dimensionally manufactured object by using an energy beam.

### Description of the Related Art

In recent years, the three-dimensional manufacturing method is progressively developed for manufacturing the three-dimensionally manufactured object by a powder bed fused bonding technique which performs a heating process by using an energy beam. In the powder bed fused bonding technique that performs the heating process by using the energy beam, fine particles called fume become a problem, which are formed by such a process that powders of the raw material have been evaporated by the energy beam and are solidified in the apparatus.

An apparatus described in Japanese Patent Application Laid-Open No. 2010-132961 forms a flow of inert gas in the apparatus, and expels the fume that has been generated in the apparatus from the inside of the apparatus. An apparatus described in Japanese Patent No. 5721886 provides a suction unit of the fume in a layer-forming portion that forms a powder bed.

Apparatuses described in Japanese Patent Application Laid-Open No. 2010-132961 and Japanese Patent No. 5721886 intend to alleviate the influence of the fume on the assumption that the fume is generated in a process of manufacturing a three-dimensionally manufactured object, and accordingly cannot reduce the total amount of the fume itself which is generated in the process of manufacturing the three-dimensionally manufactured object.

By the way, in a conventional powder bed fused bonding technique that performs a heating process by using an energy beam, the apparatus makes one beam spot overlap with a fused and solidified region and a non-solidified region which adjoins to the solidified region, and moves the energy beam (see FIGS. 7A and 7B). In other words, the apparatus moves the beam spot of one energy beam along a boundary between the solidified region and the non-solidified region, and fuses the both simultaneously to integrate the both.

Here, in the non-solidified region in the powder state, the fume tends to be generated more easily than in the solidified region in which the powder is solidified and heat tends to easily diffuse, accordingly it has been proposed to set heating quantity per unit area at a lower value for the non-solidified region than that for the solidified region. However, when the beam spot is moved along the boundary between the solidified region and the non-solidified region, it is difficult to adjust the heating quantity per unit area individually for the solidified region and the non-solidified region.

### SUMMARY OF THE INVENTION

An object of the present invention is to provide a three-dimensional manufacturing apparatus and a three-dimensional manufacturing method which are easy to adjust the heating quantity per unit area individually for a solidified region and a non-solidified region.

According to an aspect of the present invention, a three-dimensional manufacturing apparatus comprises: a layer forming unit which forms a layer of a powder material; a heating unit that heats the layer by a first energy beam which heats a fused and solidified region and a second energy beam which heats a non-solidified region adjacent to the solidified region; and a controlling unit that controls the heating unit so as to move the first energy beam and the second energy beam along a boundary between the solidified region and the non-solidified region, and to fuse and solidify a manufacturing region of the layer.

According to a further aspect of the present invention, a three-dimensional manufacturing method comprises: layer forming in which a controlling section makes a layer forming unit that can form a layer of a powder material form the layer; and heating in which the controlling section makes a heating unit that can generate a first energy beam which heats a fused and solidified region of the layer and a second energy beam which heats a non-solidified region adjacent to the solidified region heat a manufacturing region of the layer to fuse and solidify the manufacturing region, wherein, in the heating, the controlling section controls the heating unit so as to move the first energy beam and the second energy beam along a boundary between the solidified region and the non-solidified region.

The present invention can provide the three-dimensional manufacturing apparatus and the three-dimensional manufacturing method which easily adjust the heating quantity per unit area individually for the solidified region and the non-solidified region. Thereby, it is enabled to adjust the heating quantity per unit area individually for the solidified region and the non-solidified region, and to reduce the total amount of the fume itself which is generated in a process of manufacturing a three-dimensionally manufactured object.

Further features of the present invention will become apparent from the following description of exemplary embodiments with reference to the attached drawings.

### BRIEF DESCRIPTION OF THE DRAWINGS

FIG. 1 is an explanatory view of a structure of a three-dimensional manufacturing apparatus of Embodiment 1.

FIG. 2 is a block diagram of a controlling system of the three-dimensional manufacturing apparatus.

FIG. 3 is a flow chart of a process of manufacturing a three-dimensionally manufactured object.

FIGS. 4A and 4B are explanatory views of heating of boundary in conventional scanning heating. FIG. 4A is a view illustrating a laser beam scanning path on a layer of a powder material, and FIG. 4B is a perspective view of the heating of boundary by a beam spot.

FIGS. 5A, 5B and 5C are explanatory views of a laser beam in Embodiment 1. FIG. 5A is a plan view of the beam spot, FIG. 5B is a cross-sectional view taken along the line 5B-5B in FIG. 5A, and FIG. 5C is an explanatory view of an intensity distribution of the laser beam.

FIG. 6 is a flow chart for creating a manufacturing processing program.

FIGS. 7A and 7B are explanatory views of a laser beam in a comparative example. FIG. 7A is a plan view of the beam spot, and FIG. 7B is a cross-sectional view taken along the line 7B-7B in FIG. 7A.

FIGS. 8A, 8B and 8C are explanatory views of a laser beam in Embodiment 2. FIG. 8A is a plan view of the beam spot, FIG. 8B is a cross-sectional view taken along the line 8B-8B in FIG. 8A, and FIG. 8C is an explanatory view of an intensity distribution of the laser beam.

FIGS. 9A and 9B are explanatory views of laser beam control of Embodiment 3. FIG. 9A is a plan view of the beam spot, and FIG. 9B is a conceptual view of an intensity distribution of the laser beam.

FIGS. 10A and 10B are explanatory views of laser beam setting of Embodiment 4. FIG. 10A is a plan view of the beam spot, and FIG. 10B is a conceptual view of an intensity distribution of the laser beam.

FIG. 11 is an explanatory view of a structure of a three-dimensional manufacturing apparatus of Embodiment 5.

### DESCRIPTION OF THE EMBODIMENTS

Preferred embodiments of the present invention will now be described in detail in accordance with the accompanying drawings.

### Embodiment 1

The three-dimensional manufacturing apparatus in Embodiment 1 heats a non-solidified region with a second laser beam while heating a solidified region with a first laser beam, and fuses the solidified region and the non-solidified region to integrally solidify the regions. In addition, the three-dimensional manufacturing apparatus sets the heating quantity per unit area in the region which has been heated with the first laser beam so as to become larger than the heating quantity per unit area in the region which is heated with the second laser beam. Thereby, the three-dimensional manufacturing apparatus can reduce the generation itself of the fume in a powder bed fused bonding technique.

(Three-Dimensional Manufacturing Apparatus)

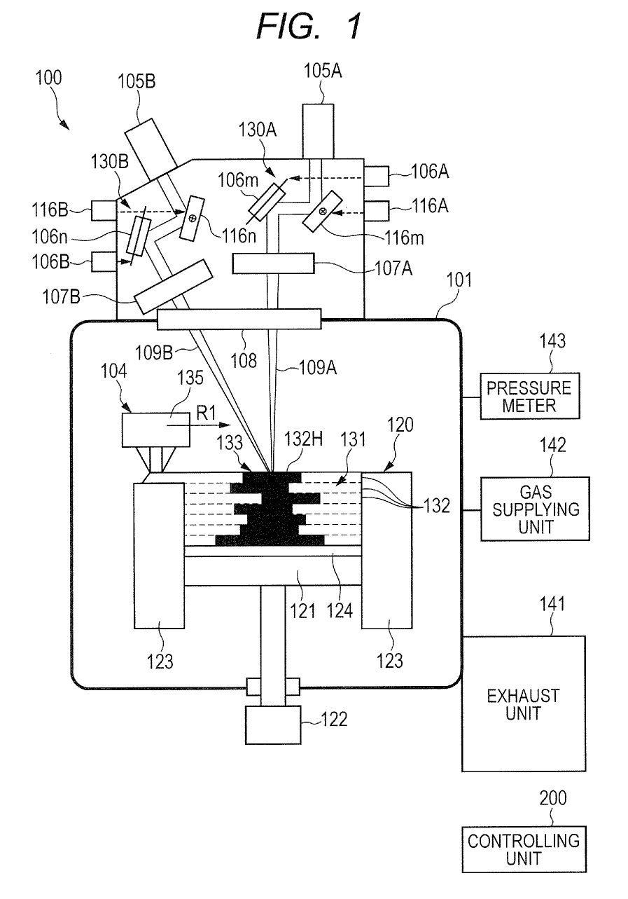

FIG. 1 is an explanatory view of a structure of a three-dimensional manufacturing apparatus of Embodiment 1. The powder bed fused bonding technique can produce a small amount and various types of manufacturing products, and manufacturing products having complicated shapes, and accordingly is progressively developed in recent years. The powder bed fused bonding technique usually forms a layer of a powder material, locally fuses the formed layer with an energy beam, and bonds the layers in a plane direction and a depth direction. Then, the technique repeats such a process for a large number of layers, stacks the layers, and thereby manufactures a manufacturing product.

As is illustrated in FIG. 1, a three-dimensional manufacturing apparatus 100 is a so-called 3D printer according to a powder bed fused bonding method. A cabinet-shaped container 101 which covers the whole is formed from stainless steel and can be hermetically sealed. A pressure meter 143 is connected to the container 101.

An exhaust unit 141 exhausts the inside of the container 101 to remove oxygen. The exhaust unit 141 includes a dry pump. A gas supplying unit 142 can supply nitrogen gas to the inside of the container 101. It is general that irradiation with an energy beam in the powder bed fused bonding technique is performed in inert gas in order to prevent oxidation of a powder material.

The exhaust unit 141 has an opening adjustment valve which can adjust an opening amount, in a portion connected to the container 101. The three-dimensional manufacturing apparatus 100 adjusts the opening adjustment valve according to the output of the pressure meter 143 while supplying the gas to the container 101 with the gas supplying unit 142, and thereby can keep the inside of the container 101 at a desired atmosphere and pressure (degree of vacuum).

A manufacturing container 120 is arranged in the container 101. The manufacturing container 120 has a layer stacking base material 124 arranged on a stage 121, which is a substrate on which layers 132 of the powder material 131 are stacked. A lifting/lowering unit 122 moves down the stage 121 stepwise at a pitch corresponding to the thickness of the layer 132.

A layer formation unit 104 which is one example of a layer forming unit can form the layer 132 of the powder material by executing a layer forming step. The layer formation unit 104 forms the layer 132 of the powder material 131, as a moving section 135 which accommodates the powder material 131 moves in the arrow R1 direction along the upper surface of the manufacturing container 120. The layer formation unit 104 forms a layer 132 of the powder material 131 on the layer stacking base material 124 or on a layer 132, and stacks the layers 132. The layer formation unit 104 forms the powder material 131 of metal powders having a particle size of several μm to several tens μm so as to have a uniform thickness of approximately 10 μm to 100 μm, by an unillustrated squeezer, a roller or the like. In Embodiment 1, a powder material of SUS 316 having a particle size of 20 μm has been used, and the layer 132 having a thickness of 40 μm has been formed by the layer formation unit 104.

Light sources 105A and 105B and heat scanning units 130A and 130B which are one example of the heating unit can generate laser beams 109A and 109B in the heating step. The light source 105B that is one example of a first generation source generates the laser beam 109B which is one example of a first energy beam. The light source 105A that is one example of a second generation source generates the laser beam 109A which is one example of a second energy beam.

The heat scanning units 130A and 130B heat the layer 132 which has been formed by the layer formation unit 104, with the two laser beams 109A and 109B. The heat scanning unit 130A biaxially scans the laser beam 109A that has been generated by the light source 105A, with scanning mirrors 106m and 116m by actuators 106A and 116A, and heats a manufacturing region in the layer 132, which corresponds to input data. The heat scanning unit 130B biaxially scans the laser beam 109B that has been generated by the light source 105B, with scanning mirrors 106n and 116n, and heats the manufacturing region in the layer 132, which corresponds to the input data.

The heat scanning units 130A and 130B heat the layer 132 in the manufacturing container 120 by the laser beams 109A and 109B, almost instantly fuses the layer 132, and solidifies the layer 132 integrally with a solid composition of the lower layer. Thereby, a desired manufacturing region of the layer 132 which has been formed in the manufacturing container 120 is changed to a solidified layer 132H.

The light sources 105A and 105B are YAG laser oscillators, and are semiconductor fiber lasers having a wavelength of 1070 mm and a power of 500 W. Optical systems 107A and 107B each include a lens that condenses the laser beam, and form a beam spot of the laser beam at a height of the layer 132. A transmission window 108 makes the laser beams 109A and 109B transmit therethrough into the container 101.

(Process of Manufacturing Manufactured Object)

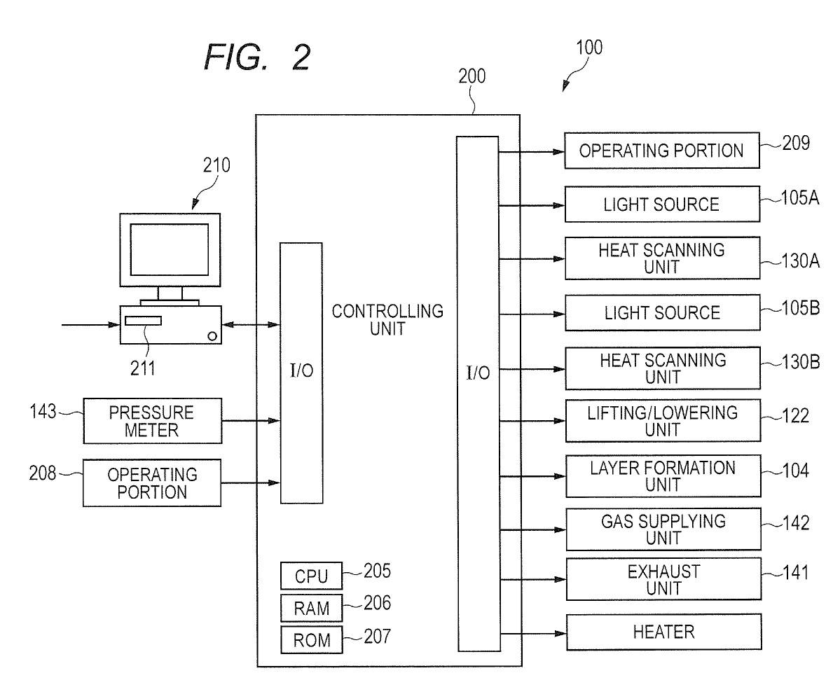

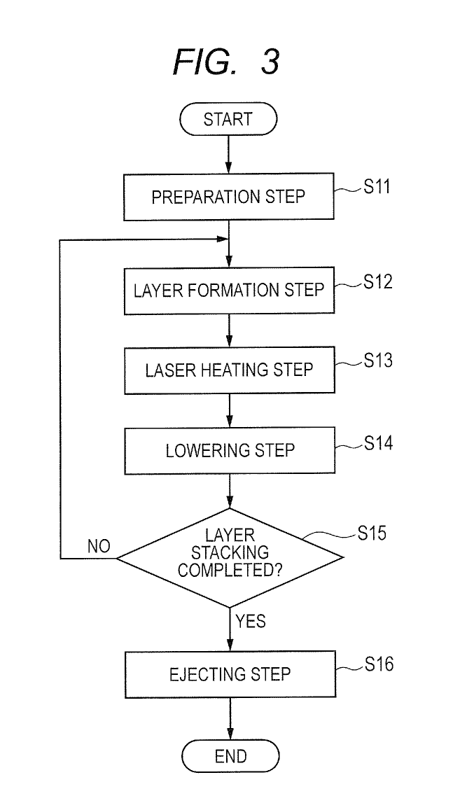

FIG. 2 is a block diagram of a controlling system of a three-dimensional manufacturing apparatus. FIG. 3 is a flow chart of a process of manufacturing a three-dimensionally manufactured object. As is illustrated in FIG. 1, a three-dimensional manufacturing apparatus 100 repeats the layer forming step and a laser heating step, and thereby manufactures a three-dimensional manufacturing product 133 on which the solidified layers 132H are stacked. The three-dimensional manufacturing apparatus 100 controls the scanning mirrors 106m, 106n, 116m and 116n to scan the laser beams 109A and 109B, and controls the light sources 105A and 105B to change the powers of the laser beams 109A and 109B.

As is illustrated in FIG. 2, the controlling section 200 holds the processing program and data of a three-dimensional manufacturing process in a RAM 206, which have been called from a ROM 207, makes a CPU 205 execute necessary calculation and control, and thereby functions as a process controller for three-dimensional manufacturing. The controlling section 200 which is one example of the controlling unit executes a manufacturing processing program that has been created by an external computer 210, and controls the three-dimensional manufacturing apparatus 100.

As is illustrated in FIG. 3, when a user instructs the start of the process through an operating portion 209, the controlling section 200 executes a preparation step (S11). In the preparation step, as is illustrated in FIG. 1, the controlling section 200 makes an exhaust unit 141 operate and exhaust the inside of the container 101. Then, when the pressure in the container 101 reaches several hundred Pa, the controlling section 200 makes the gas supplying unit 142 start to supply the gas and set the pressure and the atmosphere in the container 101. In addition, the controlling section 200 makes the lifting/lowering unit 122 operate, move the stage 121 down and thereby form a room in which the first layer 132 is formed on the layer stacking base material 124.

When the preparation step has ended, the controlling section 200 executes the layer forming step (S12). In the layer forming step, as is illustrated in FIG. 1, the controlling section 200 makes the layer formation unit 104 operate and form the layer 132 of the powder material 131 on the layer stacking base material 124 or on an already formed layer 132.

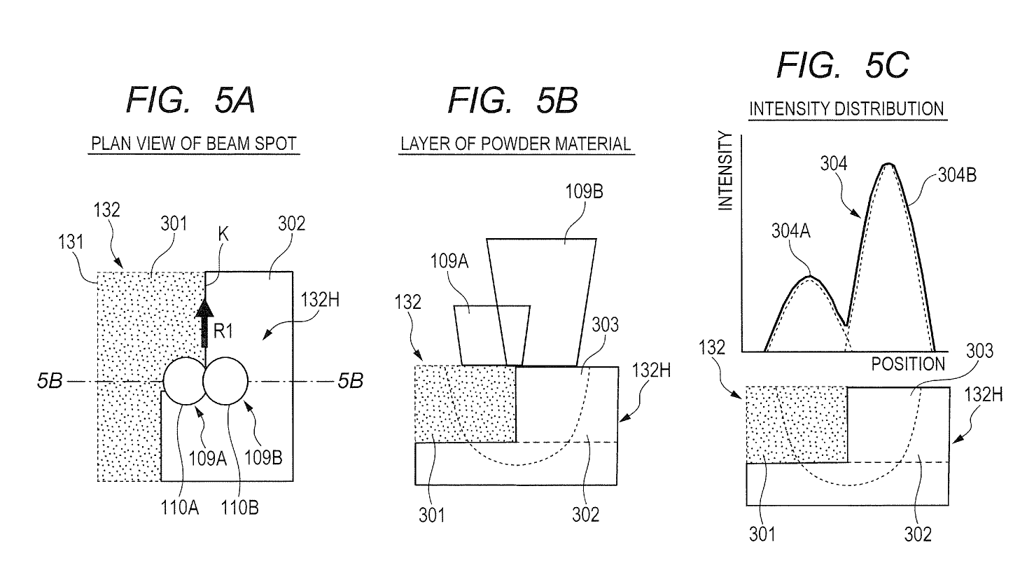

When the layer forming step has ended, the controlling section 200 executes the laser heating step (S13). The laser heating step is executed in an atmosphere at a reduced pressure or atmospheric pressure in which nitrogen gas has been introduced. The powder material 131 which is positioned in a movement path of the laser beam 109 is fused and solidified, and the surface of the layer 132 is divided into the solidified region (302: FIGS. 5A to 5C) and the non-solidified region (301: FIGS. 5A to 5C).

When the laser heating step has ended, the controlling section 200 executes a lowering step (S14). In the lowering step, as is illustrated in FIG. 1, the controlling section 200 makes the lifting/lowering unit 122 operate, move the stage 121 down and thereby form a room in which a next layer 132 is formed on the layer 132 that has been subjected to the laser heating step.

The controlling section 200 repeats the layer forming step (S12), the laser heating step (S13) and the lowering step (S14), until the number of the steps reaches the number of layer stacking necessary for the formation of the manufacturing product 133 (No in S15). When the number of the steps has reached the number of the necessary layer stacking (Yes in S15), the controlling section 200 executes an ejecting step (S16). In the ejecting step, as is illustrated in FIG. 1, the three-dimensional manufacturing apparatus stops the gas supplying unit 142 and the exhaust unit 141, supplies outer air to the inside of the container 101, waits for cooling of the manufacturing product 133, and permits the user to take out the manufacturing product 133, through a display screen of the operating portion 209.

(Prior Art Heating of Boundary)

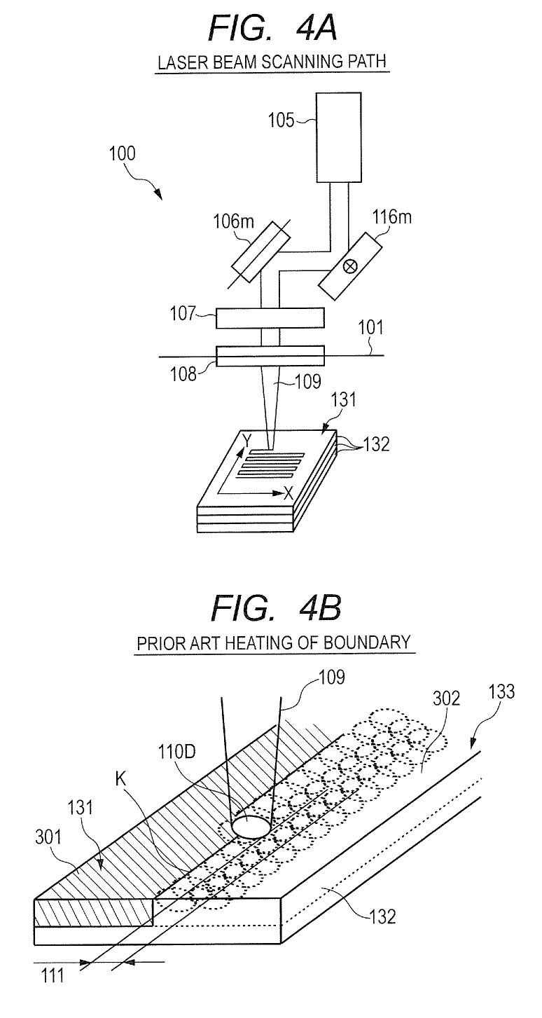

FIGS. 4A and 4B are explanatory views of heating of boundary in conventional scanning heating. In FIGS. 4A and 4B, FIG. 4A is a view illustrating a laser beam scanning path on a layer of the powder material, and FIG. 4B is a perspective view of the heating of boundary by the beam spot.

As is illustrated in FIG. 4A, the three-dimensional manufacturing apparatus 100 employs raster scanning in which linear main scanning in the X direction is repeated in the Y direction at equal intervals. The three-dimensional manufacturing apparatus 100 performs a subscan in the Y direction while performing main scanning in the X direction with the laser beam 109, and thereby irradiates the surface of the layer 132 with the laser beam 109 at a uniform irradiation density. The three-dimensional manufacturing apparatus 100 repeats the step on individual layers 132, and thereby manufactures the manufacturing product 133 illustrated in FIG. 1 into a desired shape.

As is illustrated in FIG. 4B, in the laser heating step, the three-dimensional manufacturing apparatus 100 simultaneously fuses the solidified region 302 which has been fused and solidified by the main scanning of the previous time and the unfused non-solidified region 301, and solidifies the regions integrally. Because of this, conventionally, a three-dimensional manufacturing apparatus has formed a beam spot 110D having such a size as to overlap the solidified region 302 and the non-solidified region 301, and has scanned the regions with the laser beam 109 so that the center of the beam spot 110D moves along a boundary K between the solidified region 302 and the non-solidified region 301. The diameter of the beam spot 110D has been larger than a scanning pitch 111 of the main scanning, and the beam spot 110D has heated and fused both of the solidified region 302 and the non-solidified region 301 simultaneously. The three-dimensional manufacturing apparatus has continuously executed the process in which the beam spot 110D integrally solidifies the solidified region 302 and the non-solidified region 301, along the main scanning path, and thereby has manufactured the solidified region 302 into a desired shape.

(Problem of Fume)

As is illustrated in FIG. 1, in the laser heating step, smoke which is referred to as fume is generated, when the layer 132 of the powder material 131 has been irradiated with the laser beam 109 and heated. In the powder bed fused bonding technique, the fume becomes a problem, which is generated in the container in association with heating of the powder material. The fume is a fine particle that is a condensed substance of a metal vapor which has been generated by sublimation or evaporation when the powder material 131 is rapidly heated. When the inside of the container 101 is filled with the fume, the fume adheres onto the transmission window 108 which guides the laser beam 109 therethrough into the container 101, and decreases the transmittance. Alternatively, the fume that floats in the container 101 scatters the laser beam 109, and reduces the laser beam 109 which reaches the layer 132 of the powder material 131. When the laser beam 109 that reaches the layer 132 decreases, the fusion of the powder material 131 becomes insufficient, which may cause defective manufacturing.

Incidentally, the solidified region 302 in which the powder material 131 has been already fused and solidified has higher thermal conductivity than the non-solidified region 301 of the unfused powder material 131, and the temperature resists rising than that of the non-solidified region 301, when the regions have been irradiated with the laser beam 109. Because of this, in order to fuse the solidified region 302, it is necessary to supply heating energy having a higher density to the region than that to the non-solidified region 301. However, as is illustrated in FIG. 4B, when the solidified region 302 and the non-solidified region 301 are simultaneously heated by the common beam spot 110, the laser beam 109 results in equally irradiating the non-solidified region 301 with an intensity necessary for fusing the solidified region 302. Thereby, the non-solidified region 301 is irradiated with the laser beam 109 having a high intensity than that necessary for the fusion, the temperature rises higher than the required temperature, the non-solidified region 301 becomes an overheated state, and the amount of generated fume increases. The unfused metal powder is irradiated with the laser beam 109 having an amount of energy equal to or larger than the amount necessary for the fusion, evaporation of the metal powder progresses, and the fume is formed.

Then, the three-dimensional manufacturing apparatus in Embodiment 1 heats the non-solidified region 301 with the second laser beam 109A while heating the solidified region 302 with the first laser beam 109B. In addition, the second laser beam 109A that heats the non-solidified region 301 is configured so as to have a smaller heating performance by the beam spot, in other words, a smaller power of the laser beam than the first laser beam 109B that heats the solidified region 302.

(Features of Beam Spot)

FIGS. 5A to 5C are explanatory views of a laser beam in Embodiment 1. FIG. 5A is a plan view of the beam spot, FIG. 5B is a cross-sectional view taken along the line 5B-5B in FIG. 5A, and FIG. 5C is an explanatory view of an intensity distribution of the laser beam.

As is illustrated in FIG. 5A, in Embodiment 1, the laser beam 109B moves along the boundary K, and heats the solidified region 302 again which the laser beam 109A has already fused and solidified. The laser beam 109A moves along the boundary K, and heats the non-solidified region 301 which is adjacent to the solidified region 302.

The laser beams 109A and 109B are main-scanned along the boundary K in the arrow R1 direction, fused and solidified both of the non-solidified region 301 and the solidified region 302, and thereby manufacturing solidified layers 132H into a desired shape. In the process of fusing the non-solidified region 301 by the laser beam 109A to manufacture the solidified region 302, the laser beam 109B fuses the solidified region 302 again and solidifies the region. In addition, the intensity of the laser beam 109A that irradiates the non-solidified region 301 is set to be smaller than the intensity of the laser beam 109B which irradiates the solidified region 302.

A main scanning speed of the laser beams 109A and 109B is 200 mm/sec. The diameters of the beam spots 110A and 110B of the laser beams 109A and 109B are each 60 μm. The centers of the beam spots 110A and 110B are positioned at positions 20 μm away from the boundary K between the non-solidified region 301 and the solidified region 302, respectively, and accordingly the beam spots 110A and 110B overlap with each other at a part of the edge portions.

As is illustrated in FIG. 5B, the layer 132 is fused in a range of a fused region 303 that includes the non-solidified region 301 and the solidified region 302, and is integrally solidified. The depth of the fused region 303 is deeper than the thickness of the layer 132, which is 40 μm, and is solidified integrally with an immediately preceding layer 132.

As is illustrated in FIG. 5C, the heating energy distribution 304 that is the total of the laser beams 109A and 109B shows a distribution in which the individual heating energy distributions 304A and 304B of the laser beams 109A and 109B are superimposed.

The second laser beam 109A that irradiates the non-solidified region 301 has smaller heating energy than the first laser beam 109B that irradiates the solidified region 302. The light source 105A illustrated in FIG. 1 sets the power of the second laser beam 109A at 40 W, and the light source 105B sets the power of the first laser beam 109B at 100 W.

In order to reduce the amount of the fume, the power of the light source 105A is adjusted so that the minimum heating energy necessary for fusing the non-solidified region 301 down to the desired depth at a desired position with the second laser beam 109A can be secured. In order to sufficiently fuse the layer corresponding to the thickness of the solidified region 302, the power of the light source 105B is adjusted so that the heating energy necessary for fusing the solidified region 302 down to a desired depth at a desired position with the first laser beam 109B can be secured. The heating energy of the second laser beam 109A is smaller than the heating energy necessary for manufacturing the solidified region 302 down to the desired depth.

The superimposition of the laser beams 109A and 109B is adjusted so that the position at which the total heating energy distribution 304 is locally minimized is positioned at the boundary K between the non-solidified region 301 and the solidified region 302. The beam spots 110A and 110B of the laser beams 109A and 109B are aligned in a direction perpendicular to the scanning direction.

(Manufacturing Processing Program)

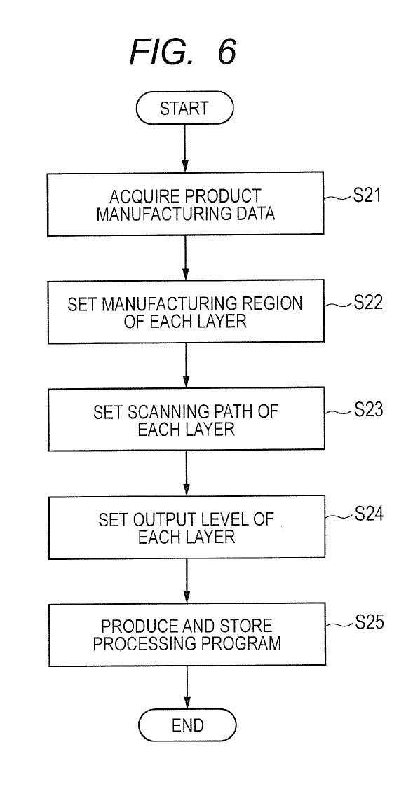

FIG. 6 is a flow chart for creating a manufacturing processing program. As is illustrated in FIG. 2, the controlling section 200 automatically creates a manufacturing processing program for the manufacturing product 133 by the three-dimensional manufacturing apparatus 100, based on the design data for the manufacturing product 133, which has been input from an external computer 210. The CPU 205 acquires the design data (CAD data) for the manufacturing product 133 from the external computer 210 (S21). The CPU 205 sets a manufacturing region for each of the layers 132, based on the design data for the manufacturing product 133 (S22).

The CPU 205 sets the scanning path of each of the laser beams 109A and 109B, for each manufacturing region of the layer 132 in manufacturing of each layer 132 (S23). The CPU 205 sets the power level of the laser beam 109 at each point on the scanning paths of the laser beams 109A and 109B for each of the manufacturing regions (S24). The CPU 205 creates the manufacturing processing program for the manufacturing product 133 by combining the scanning paths and the power levels of the laser beams 109A and 109B for each of the manufacturing regions (S25). The manufacturing processing program is transmitted to the external computer 210, and is stored in a recording medium 211.

The manufacturing processing program that is one example of the program is stored in the recording medium 211, and the controlling section 200 which is one example of the computer executes each of the steps of the three-dimensional manufacturing method. The three-dimensional manufacturing apparatus 100 executes the laser heating step (S13: FIG. 3) by using a manufacturing processing program that performs scanning heating with the two laser beams 109A and 109B. Thereby, the three-dimensional manufacturing apparatus 100 fusing-bonds the non-solidified region 301 and the solidified region 302 of the layer 132 of the powder material 131, and manufactures the manufacturing product 133 having a desired shape.

### Comparative Example

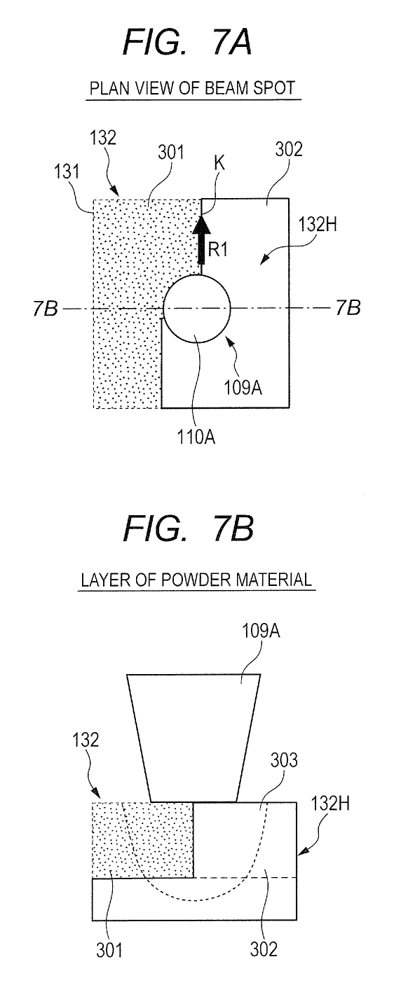

FIGS. 7A and 7B are explanatory views of a laser beam in a comparative example (in the case where layer was scanned only with laser beam 109A). FIG. 7A is a plan view of the beam spot, and FIG. 7B is a cross-sectional view taken along the line 7B-7B in FIG. 7A.

As is illustrated in FIG. 1, in the comparative example, a manufacturing region of the layer 132 is fused and solidified only by the light source 105A and the heat scanning unit 130A, and the manufacturing product is three-dimensionally manufactured. The three-dimensional manufacturing apparatus scans the layer 132 with the laser beam 109A which has been generated by the light source 105A while operating the scanning mirrors 106m and 116m, and heats the manufacturing region of the layer 132.

As is illustrated in FIG. 7A, in the comparative example, the beam spot 110A of the laser beam 109A is set to be larger than the scanning pitch (111: FIG. 4B) of the main scanning. The solidified region 302 and the non-solidified region 301 are scanned with the laser beam 109A so that the center of the beam spot 110A moves on the boundary K between the regions. The laser beam 109A irradiates both of the non-solidified region 301 and the solidified region 302. The power of the light source 105A is set at 100 W so that the laser beam 109A can fuse the solidified region 302 down to a depth of 50 μm at a desired position.

In the three-dimensional manufacturing apparatus 100, the light source 105A was set as described above, a manufacturing product (133: FIG. 1) was manufactured which had a rectangular solid with a length of 20 mm in the main scanning direction, a length of 50 mm in the sub-scanning direction, and a height of 40 mm, and a change of the transmittance of the transmission window 108 was measured. The manufacturing time period from the start to the end was 100 hours.

TABLE 1

Transmittance (%)

| | Before | After |
|---|---|---|
| | manufacturing | manufacturing |
| Embodiment 1 | 92 | 90 |
| Comparative | 92 | 80 |
| Example | | |

As is illustrated in Table 1, in the comparative example, the transmittance of the transmission window 108 at a wavelength of 1070 nm decreased from 92% before the experiment to 80%, through 100 hours of the manufacturing. On the other hand, in Embodiment 1 which used the laser beams 109A and 109B, when the manufacturing was equally performed for 100 hours, the transmittance of the transmission window 108 at the wavelength of 1070 nm decreased only to 90% from 92% before the experiment. When Embodiment 1 is compared with the comparative example, the transmittance of the transmission window 108 is higher in Embodiment 1. In other words, the generation of the fume which causes the reduction of the transmittance was less in Embodiment 1. Therefore, it is understood that Embodiment 1 is an effective technique for the reduction of the fume.

### Effect of Embodiment 1

The three-dimensional manufacturing apparatus in Embodiment 1 can manufacture the manufacturing product 133 which has a dense composition and little partial dispersion in quality, by irradiating the thin layer 132 with the laser beams 109A and 109B having a desired pattern, and fusing and solidifying the manufacturing region of each of the layers.

The three-dimensional manufacturing apparatus in Embodiment 1 moves the laser beams 109A and 109B along the boundary between the solidified region 302 and the non-solidified region 301, and fuses and solidifies the manufacturing region of the layer 132. Because of this, the three-dimensional manufacturing apparatus can easily adjust the heating conditions of the solidified region 302 and the heating condition of the non-solidified region 301, and can avoid overheating of the non-solidified region 301 while sufficiently fusing the solidified region 302.

In Embodiment 1, in the path through which the beam spots 110A and 110B have passed on the surface position of the layer 132, the heating quantity per unit area and per unit time of the laser beam 109B is larger than that of the laser beam 109A. Because of this, the three-dimensional manufacturing apparatus can suppress the overheating of the non-solidified region 301 to reduce the generation of the fume during manufacturing, while sufficiently fusing the solidified region 302 and forming the dense composition.

In Embodiment 1, the beam spot 110B of the laser beam 109B on the surface position of the layer 132 partially overlaps the beam spot 110A of the laser beam 109A in the vicinity of the boundary K. Because of this, insufficient heating in the vicinity of the boundary K hardly occurs.

In Embodiment 1, the total heating quantity of the laser beam 109B and the laser beam 109A on the surface position of the layer 132 is larger at the center position of the beam spot of the laser beam 109B than at the center position of the beam spot of the laser beam 109A. Because of this, the three-dimensional manufacturing apparatus can avoid the overheating of the non-solidified region 301 while sufficiently heating the solidified region.

In Embodiment 1, the positions of the beam spots 110A and 110B in the moving direction along the boundary K are the same for the laser beam 109A and the laser beam 109B. Because of this, it is easy to scan the layer with the laser beam 109A and the laser beam 109B at high speed to enhance the manufacturing speed.

### Embodiment 2

As is illustrated in FIGS. 5A to 5C, the three-dimensional manufacturing apparatus in Embodiment 1 has partially superimposed the beam spots 110A and 110B of the laser beams 109A and 109B on each other, and has heated the layer 132 of the powder material. In contrast to this, in Embodiment 2, the beam spot of the laser beam 109B on the surface position of the surface layer 132 is separated from the beam spot of the laser beam 109A. The three-dimensional manufacturing apparatus scans the layers 132 while keeping such a state that the beam spots 110A and 110B of the laser beams 109A and 109B are separated from each other, and thereby heats the layer 132 of the powder material 131.

(Features of Beam Spot)

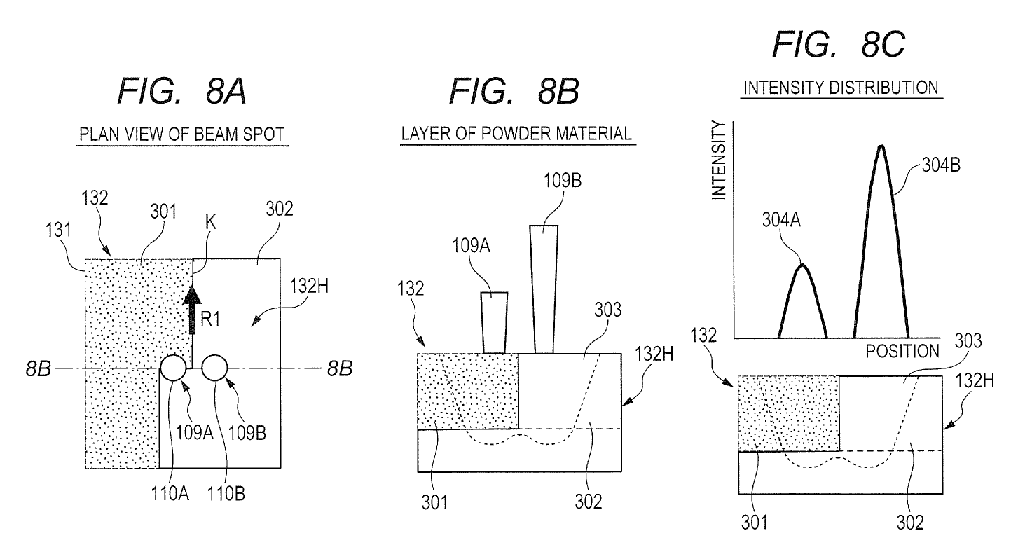

FIGS. 8A to 8C are explanatory views of a laser beam in Embodiment 2. FIG. 8A is a plan view of the beam spot, FIG. 8B is a cross-sectional view taken along the line 8B-8B in FIG. 8A, and FIG. 8C is an explanatory view of an intensity distribution of the laser beam. In Embodiment 2, the structure and the control are the same as those in Embodiment 1, except that the beam spots 110A and 110B of the laser beams 109A and 109B are separated. Because of this, in FIGS. 8A to 8C, common reference numerals to those in FIGS. 7A and 7B will be put on the same structure as in Embodiment 1, and redundant descriptions will be omitted.

As is illustrated in FIG. 8A, the beam spots 110A and 110B of the laser beams 109A and 109B are separated.

The diameter of the beam spot 110A of the laser beam 109A is 30 μm. A distance from the boundary K between the solidified region 302 and the non-solidified region 301 to the center of the beam spot 110A is 40 μm. A diameter of the beam spot 110B of the laser beam 109B is 30 μm. A distance from the boundary K between the solidified region 302 and the non-solidified region 301 to the center of the beam spot 110B is 40 μm.

As is illustrated in FIG. 8B, the laser beams 109A and 109B fuse and solidify the layer 132 of the powder material 131 in a range of the fused region 303 that includes the non-solidified region 301 and the solidified region 302. The depth of the fused region 303 is larger than the thickness of the layer 132, which is 40 μm.

As is illustrated in FIG. 8C, the laser beams 109A and 109B are separated, and accordingly the individual heating energy distributions 304A and 304B of the laser beams 109A and 109B are independent in the total heating energy distribution 304.

The second laser beam 109A that irradiates the non-solidified region 301 has smaller heating energy than the first laser beam 109B that irradiates the solidified region 302. The light source 105A sets the power of the second laser beam 109A at 60 W, and the light source 105B sets the power of the first laser beam 109B at 130 W. Thereby, as for the layer 132 of the powder material 131, a thickness of 40 μm is fused.

It is desirable that the amount of heating energy of the light source 105A is set at the minimum amount necessary for fusing the non-solidified region 301 down to a desired depth at a desired position. The light source 105B satisfies the minimum heating energy by which the solidified region 302 can be manufactured to a desired depth at a desired position. Accordingly, the light source 105A does not have an amount of heating energy enough to fuse the solidified region 302 down to a desired depth.

In order to reduce the amount of fume, it is desirable that the laser beams 109A and 109B are aligned in a direction perpendicular to the scanning direction of the laser beams 109A and 109B.

The laser beams 109A and 109B were set as described above, and similar test manufacturing to that in Embodiment 1 and the comparative example were performed. Then, the transmittance of the transmission window 108 at a wavelength of 1070 nm was evaluated after the manufacturing was performed for 100 hours.

TABLE 2

Transmittance (%)

| | Before | After |
|---|---|---|
| | manufacturing | manufacturing |
| Embodiment 2 | 92 | 90 |
| Comparative | 92 | 80 |
| Example | | |

As is illustrated in Table 2, in Embodiment 2 which used the laser beams 109A and 109B, when the manufacturing was equally performed for 100 hours, the transmittance of the transmission window 108 at the wavelength of 1070 nm decreased only to 90% from 92% before the experiment.

Therefore, it is determined that the generation of the fume which causes the reduction of the transmittance has been little equally to that in Embodiment 1. Therefore, it is understood that Embodiment 2 is an effective technique for the reduction of the fume.

### Embodiment 3

As is illustrated in FIG. 5A, in Embodiment 1, the layer 132 of the powder material 131 has been scanned and heated in such a state that a positional relationship in a main scanning direction between the beam spots 110A and 110B has been fixed. In contrast to this, in Embodiment 3, the positions of the beam spots 110A and 110B in the main scanning direction are variably controlled during main scanning. In addition, as for the positions in the moving direction along the boundary K of the beam spots 110A and 110B, the laser beam 109A that heats the non-solidified region 301 is positioned in a region fused and solidified later than a region of the beam spot of the laser beam 109B that heats the solidified region 302.

(Laser Beam Control)

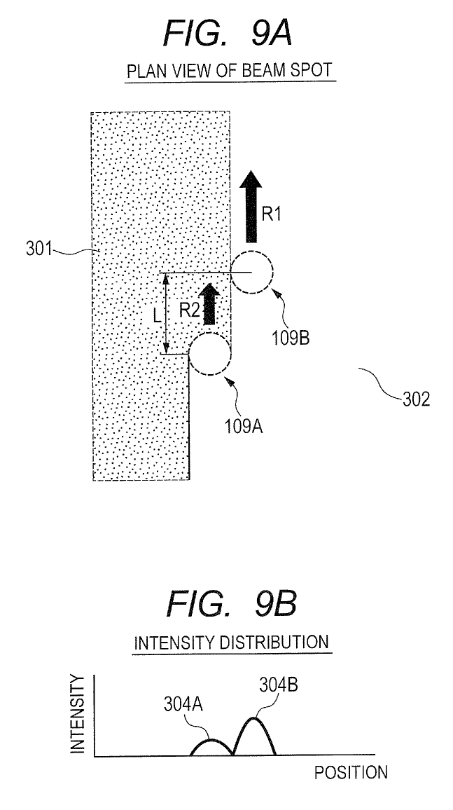

FIGS. 9A and 9B are explanatory views of the laser beam control of Embodiment 3. FIG. 9A is a plan view of the beam spot, and FIG. 9B is a conceptual view of an intensity distribution of the laser beam. In Embodiment 3, the structure and the control are the same as those in Embodiment 1, except that the distance in the main scanning direction between the beam spots 110A and 110B of the laser beams 109A and 109B is variable. Because of this, in FIGS. 9A and 9B, common reference numerals to those in FIGS. 5A to 5C will be put on the same structure as in Embodiment 1, and redundant descriptions will be omitted.

As is illustrated in FIG. 9A, it is desirable that the second laser beam 109A executes the fusing and solidification of the non-solidified region 301 at almost constant speed and time interval in the main scanning direction.

As is illustrated in FIG. 9B, the second laser beam 109A fixes the power so as to correspond to the minimum heating energy necessary for fusing the non-solidified region 301 down to a desired depth at a desired position. Because of this, if the scanning speed or the scanning time interval varies, the excess and deficiency of heating become easy to occur in the non-solidified region 301. Incidentally, the scanning interval time means a time interval which the beam spot spends in passing through the same position in a direction along a main scanning line for each main scanning.

However, the dimension of the component in the main scanning direction differs depending on the position, and accordingly the scanning time interval varies according to the dimension of the component in the main scanning direction. In addition, when the scanning time interval is short, the next heating and fusion starts in a state in which the temperature of the solidified region 302 is high, and accordingly even when the power of the second laser beam 109A is the same, there is a tendency that the temperature of the irradiated non-solidified region 301 becomes excessively high. Then, in Embodiment 3, in order to avoid the overheating of the non-solidified region 301 at the position at which the dimension in the main scanning direction of the component is short, the distance L in the main scanning direction between the beam spots 110A and 110B of the laser beams 109A and 109B is set to be large.

As is illustrated in FIG. 6, the CPU 205 sets the manufacturing region of each of the layers (S22), and then extracts positions at which the dimension in the main scanning direction is short in the manufacturing region. Then, in the position in which the dimension of the main scanning direction is short, the CPU 205 sets a scanning plan for the laser beams 109A and 109B so that the distance L of the beam spots 110A and 110B of the laser beams 109A and 109B is set to be large (S23).

Thereby, the three-dimensional manufacturing apparatus can reduce the variation of the heated state of the non-solidified region 301 at each position in the main scanning direction, and can adjust the excess and deficiency of heating for the non-solidified region 301 in each portion of the manufacturing region of each layer. The three-dimensional manufacturing apparatus can prevent the fume originating in the excessive heating for the non-solidified region 301 from increasing.

### Embodiment 4

As is illustrated in FIG. 8A, in Embodiment 2, the beam spots 110A and 110B have been separated from each other in a direction perpendicular to the main scanning direction. In contrast to this, in Embodiment 4, the laser beams 109A and 109B have been overlapped in the direction perpendicular to the main scanning direction.

(Laser Beam Setting)

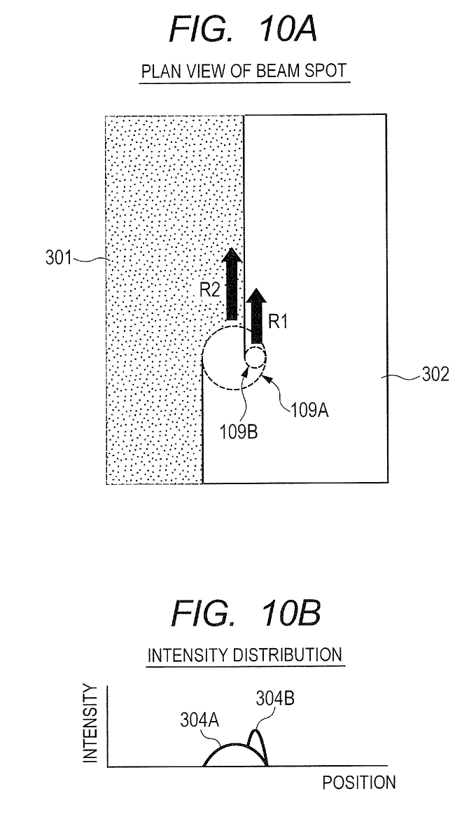

FIGS. 10A and 10B are explanatory views of laser beam setting of Embodiment 4. FIG. 10A is a plan view of the beam spot, and FIG. 10B is a conceptual view of an intensity distribution of the laser beam. In Embodiment 4, the structure and the control are the same as those in Embodiment 1, except that the beam spots 110A and 110B of the laser beams 109A and 109B overlap each other. Because of this, in FIGS. 10A and 10B, common reference numerals to those in FIGS. 5A to 5C will be put on the same structure as in Embodiment 1, and redundant descriptions will be omitted.

As is illustrated in FIG. 10A, it is desirable that the fusing and solidification of the non-solidified region 301 is executed in a wide range in the direction perpendicular to the main scanning direction. This is because the amount of manufacturing per one main scanning increases and the productivity is enhanced. In addition, it is desirable to heat and fuse the solidified region 302 in a limited narrow region adjacent to the non-solidified region 301. This is because it is desirable to avoid useless heating for the manufacturing product 133, and to increase the rate at which the input electric power is allocated to the manufacturing.

Then, in Embodiment 4, the beam spot 110B having a small diameter has been overlapped with the beam spot 110A having a large diameter so that a narrow range of the solidified region 302 adjacent to the non-solidified region 301 can be intensively and efficiently heated. The positional relationship of the beam spots 110A and 110B in the main scanning direction is fixed, and the beam spot 110A heats the solidified region 302 and the non-solidified region 301 with a comparatively small energy density. In addition, the solidified region 302 adjacent to the non-solidified region 301 is heated by the beam spot 110B having a high energy density.

In Embodiment 4, the layer 132 of the powder material 131 is scanned and heated in such a state that the positional relationship of the beam spots 110A and 110B in the main scanning direction is fixed. In Embodiment 4, as for the areas of the beam spots 110A and 110B on the surface position of the layer 132, the area is larger in the laser beam 109A than in the laser beam 109B. Because of this, the area increases which can be fused and solidified in one main scanning, and the productivity is enhanced. In addition, the area of the solidified region 302 is reduced which is fused again, and unnecessary heating for the solidified region 302 can be reduced.

### Embodiment 5

As is illustrated in FIG. 1, in Embodiment 1, the heat scanning units 130A and 130B are provided for the laser beams 109A and 109B, respectively. In contrast to this, in Embodiment 5, a heat scanning unit 130 which is one example of a common scanning unit scans the laser beam 109B and the laser beam 109A, in common. The common heat scanning unit 130 makes the laser beams 109A and 109B scan the layer 132, and heats the layer 132 of the powder material 131.

(Heat Scanning Unit)

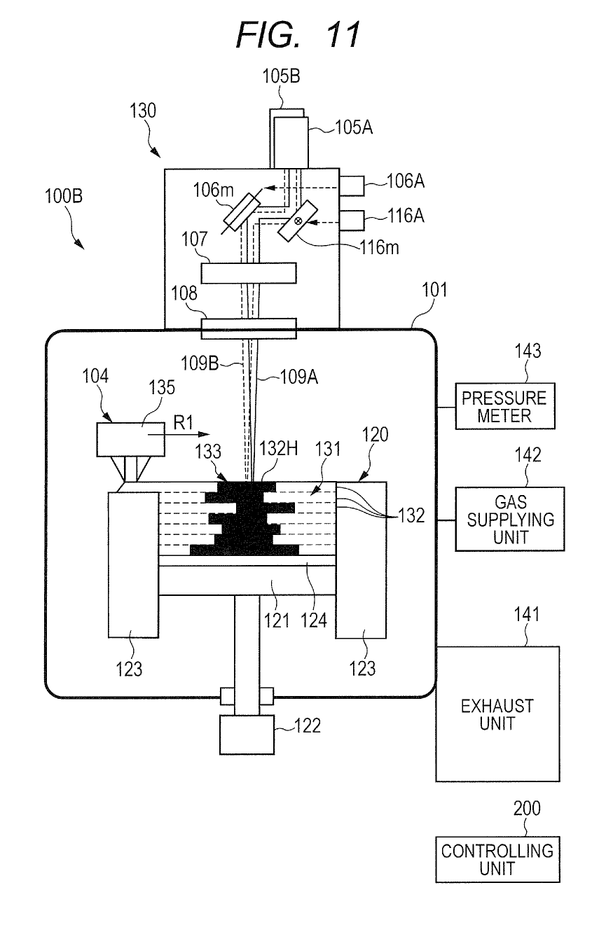

FIG. 11 is an explanatory view of a structure of a three-dimensional manufacturing apparatus of Embodiment 5. As is illustrated in FIG. 11, the three-dimensional manufacturing apparatus 100B has the same structure as that in Embodiment 1, expect that the heat scanning unit 130 is common to the laser beams 109A and 109B. Because of this, in FIG. 11, the same reference numerals as those in FIG. 1 will be put on the common structure to that in Embodiment 1, and redundant descriptions will be omitted.

In the case where the positional relationship in the main scanning direction between the beam spots 110A and 110B is fixed as in Embodiment 4, it is possible to scan the laser beams 109A and 109B with the heat scanning unit 130.

As is illustrated in FIG. 11, a light source 105A generates a laser beam 109A of which the power is variable. A light source 105B generates a laser beam 109B of which the power is variable. The light sources 105A and 105B are arranged adjacent to each other in a direction perpendicular to the paper surface, and are arranged so that the laser beams 109A and 109B are incident diagonally on the surface of the layer 132 in the plane perpendicular to the paper surface.

The heat scanning unit 130 makes the laser beam 109A which has been generated by the light source 105A and the laser beam 109B which has been generated by the light source 105B biaxially scan the layer 132 with the scanning mirrors 106m and 116m by the actuators 106A and 116A in common. Thereby, the laser beams heat the manufacturing region according to the input data in the layer 132.

Because of this, the number of the heat scanning units 130 is reduced, and in the heating step, the variation of the relative positional relationship between the beam spots 110A and 110B is also reduced.

### OTHER EMBODIMENT

The three-dimensional manufacturing method and the three-dimensional manufacturing apparatus according to the present invention are not limited by the specific structure of each section, the forms of the components, and the actual dimensions in Embodiment 1. The three-dimensional manufacturing method and the three-dimensional manufacturing apparatus can be achieved also by another embodiment in which a part or all of the structures of Embodiment 1 are replaced with equivalent members.

Accordingly, the wavelength of the energy beam, the type of the laser oscillator, the beam spot size of the laser beam, the power setting of the light source, the irradiation position of the laser beam, the manufacturing container, and a device for forming a layer of the powder material can be changed into a desired specification. The powder material 131 is not limited to stainless steel particles. Titanium, iron, aluminum, silicon, metal carbide, metal nitride, metal oxide, ceramic particles and the like can be freely selected. The gas to be introduced into the container 101 can also be changed arbitrarily. For instance, it is also effective in enhancing the strength to introduce a mixed gas in which hydrogen gas is mixed with nitrogen gas, argon gas or the like, and to perform manufacturing under the reductive atmosphere. It is also acceptable to heat the layer 132 to a temperature lower than the fusing temperature, to sinter the powder material, and to perform the three-dimensional manufacturing.

In Embodiment 1, the powers of the laser beams 109A and 109B are fixed at a fixed ratio, but the powers of the laser beams 109A and 109B may be made different at each position of the manufacturing region of the layer 132 of the powder material 131. For instance, the laser beam 109A that heats the non-solidified region 301 keeps a constant power in order to avoid the fluctuations in the fusing condition. On the other hand, it is conceivable to change the power of the laser beam 109B which heats the solidified region 302 so as to reduce variations of the re-fused state of the solidified region 302, based on the estimated temperature of the solidified region 302. It is also acceptable to invert the allocation of the solidified region 301 and the non-solidified region 302 with respect to the beam spots 110A and 110B, in the step of heating and fusing one layer 132, and to invert the relationship of the magnitude of the power between the laser beams 109A and 109B along with the above inversion. In a position at which the positional relationship between the non-solidified region 301 and the solidified region 302 of the manufacturing region is reversed, it is also acceptable to heat the solidified region 302 with the laser beam 109A, and to heat the non-solidified region 301 with the laser beam 109B.

In Embodiment 3, it is also acceptable to change the powers of the laser beams 109A and 109B simultaneously with the change of the distance L in the moving direction of the beam spots 110A and 110B. Alternatively, it is also acceptable to lower the powers of the laser beams 109A and 109B at a position at which the dimension of the main scanning direction is short, while keeping the distance L in the moving direction of the beam spots 110A and 110B constant.

The three-dimensional manufacturing apparatus in Embodiment 1 fixes the positional relationship between the beam spots 110A and 110B, and heats the layer 132 of the powder material 131. However, the three-dimensional manufacturing apparatus uses two independent heat scanning units 130A and 130B, and accordingly can arbitrarily change the positional relationship between the beam spots 110A and 110B, in the scanning direction and in a direction perpendicular to the scanning direction. The change of the positional relationship between the beam spots 110A and 110B can be used for various objects. For instance, as has been described in Embodiment 3, it is also acceptable to change the positional relationship between the beam spots 110A and 110B, and to alleviate the fluctuations in the heating conditions for each portion of the manufacturing region. Specifically, in the case where the independent heat scanning units 130A and 130B are provided for the laser beams 109A and 109B, it is possible to position the laser beams 109A and 109B so as to reduce the fluctuations in the heating conditions for each portion of the manufacturing region.

After having raster scanned and solidified the manufacturing region, the three-dimensional manufacturing apparatus may move the laser beams 109A and 109B so as to move the beam spots 110A and 110B along the contour of the manufacturing region. In this case, it is desirable to change the relative positional relationship between the beam spots 110A and 110B according to the positional relationship between the non-solidified region 301 and the solidified region 302 of the manufacturing region.

In Embodiment 1, the three-dimensional manufacturing apparatus has solidified the manufacturing region of each layer by a raster scanning method of repeating the main scanning in a sub-scanning direction. However, the three-dimensional manufacturing apparatus may adopt energy beam movement method other than the raster scanning method. The three-dimensional manufacturing apparatus may adopt spiral movement, swirling movement toward the contour from the center, swirling movement toward the center from the contour, or the like.

In Embodiment 1, a laser beam of a YAG laser having a wavelength of 1070 nm has been used as an energy beam. However, the energy beam may be replaced with a laser beam having another wavelength and/or by another oscillation source, or an electronic beam. However, when the electronic beam is used, it is necessary to highly evacuate the container 101 illustrated in FIG. 1, and to keep the inside of the container 101 at a low pressure state.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-073537, filed Mar. 31, 2016, which is hereby incorporated by reference herein in its entirety.

What is claimed is:

1. A three-dimensional manufacturing apparatus comprising:
a layer forming unit which forms a layer of a powder material;
a heating unit that heats the layer by a first energy beam which heats a fused and solidified region and a second energy beam which heats a non-solidified region adjacent to the solidified region; and
a controlling unit that controls the heating unit so as to move the first energy beam and the second energy beam along a boundary between the solidified region and the non-solidified region, and to fuse and solidify a manufacturing region of the layer.

2. The three-dimensional manufacturing apparatus according to claim 1, wherein a heating quantity per unit area of a region through which a beam spot has passed on a surface position of the layer is larger in the first energy beam than in the second energy beam.

3. The three-dimensional manufacturing apparatus according to claim 1, wherein a heating quantity per unit time in a region through which a beam spot has passed on a surface position of the layer is larger in the first energy beam than in the second energy beam.

4. The three-dimensional manufacturing apparatus according to claim 2, wherein an area of the beam spot on the surface position of the layer is larger in the second energy beam than in the first energy beam.

5. The three-dimensional manufacturing apparatus according to claim 2, wherein the heating unit comprises: a first generation source that generates the first energy beam; a second generation source that generates the second energy beam; and a common scanning unit that commonly scans the first energy beam and the second energy beam.

6. The three-dimensional manufacturing apparatus according to claim 2, wherein the beam spot of the first energy beam on the surface position of the layer is separated from the beam spot of the second energy beam.

7. The three-dimensional manufacturing apparatus according to claim 2, wherein the beam spot of the first energy beam on the surface position of the layer partially overlaps with the beam spot of the second energy beam.

8. The three-dimensional manufacturing apparatus according to claim 7, wherein a total heating quantity of the first energy beam and the second energy beam on the surface position of the layer is larger at a center position of the beam spot of the first energy beam than at a center position of the beam spot of the second energy beam.

9. The three-dimensional manufacturing apparatus according to claim 2, wherein the beam spot of the second energy beam is in a region fused and solidified later than a region of the beam spot of the first energy beam, along the boundary in a moving direction on the surface position of the layer.

10. A three-dimensional manufacturing method comprising:
layer forming in which a controlling section makes a layer forming unit that can form a layer of a powder material form the layer; and
heating in which the controlling section makes a heating unit that can generate a first energy beam which heats a fused and solidified region of the layer and a second energy beam which heats a non-solidified region adjacent to the solidified region heat a manufacturing region of the layer to fuse and solidify the manufacturing region, wherein
in the heating, the controlling section controls the heating unit so as to move the first energy beam and the second energy beam along a boundary between the solidified region and the non-solidified region.

11. A program for operating a computer to execute the three-dimensional manufacturing method, wherein the three-dimensional manufacturing method comprises:
layer forming in which a controlling section makes a layer forming unit that can form a layer of a powder material form the layer; and
heating in which the controlling section makes a heating unit that can generate a first energy beam which heats a fused and solidified region of the layer and a second energy beam which heats a non-solidified region adjacent to the solidified region heat a manufacturing region of the layer to fuse and solidify the manufacturing region, and wherein
in the heating, the controlling section controls the heating unit so as to move the first energy beam and the second energy beam along a boundary between the solidified region and the non-solidified region.

12. A non-transitory computer-readable recording medium storing a program for operating a computer to execute the three-dimensional manufacturing method, wherein the three-dimensional manufacturing method comprises:
layer forming in which a controlling section makes a layer forming unit that can form a layer of a powder material form the layer; and
heating in which the controlling section makes a heating unit that can generate a first energy beam which heats a fused and solidified region of the layer and a second energy beam which heats a non-solidified region adjacent to the solidified region heat a manufacturing region of the layer to fuse and solidify the manufacturing region, and wherein,
in the heating, the controlling section controls the heating unit so as to move the first energy beam and the second energy beam along a boundary between the solidified region and the non-solidified region.
